(19) United States
(12) Patent Application Publication
(10) Pub. No.: US 2020/0327499 A1
(43) Pub. Date: Oct. 15, 2020

(54) SYSTEM AND METHOD FOR DIGITAL CONTRACT MANAGEMENT

(71) Applicant: Sandhya Ganapathy, Tampa, FL (US)

(72) Inventor: Sandhya Ganapathy, Tampa, FL (US)

(21) Appl. No.: 16/439,551

(22) Filed: Jun. 12, 2019

(30) Foreign Application Priority Data
Apr. 15, 2019 (IN) 201941015080

(51) Int. Cl. G06Q 10/10; G06F 16/27

(52) U.S. Cl. CPC G06Q 10/10; G06F 16/27

(57) ABSTRACT

A system for digital contract management includes a processing subsystem. The processing system includes a retrieval module to retrieve one or more parameters from a plurality of users for generating a plurality of clauses for a contract. The processing subsystem includes a template module to identify the one or more parameters and provide a pre-arranged template. The processing subsystem includes a clause comparing module to compare the one or more parameters with the plurality of clauses within the pre-arranged template. The processing subsystem includes a clause generation module to generate the plurality of clauses by an analysis technique in the template. The processing subsystem includes a validation module to validate a plurality of generated clauses of the contract based on a predefined set of instructions. The processing subsystem includes a monitoring module to monitor a validated contract according to the one or more parameters for a predefined time interval.

### CROSS-REFERENCE TO RELATED APPLICATION

This application claims the benefit of Complete Patent Application bearing application no. 201941015080, filed on Apr. 14, 2019 in India.

### FIELD OF INVENTION

Embodiments of a present disclosure relates to field of digital contract, and more particularly to a system and method for digital contract management.

### BACKGROUND

Currently, contract management enables systematically and efficiently managing contract creation, execution, and analysis for the purpose of maximizing financial and operational performance. The management of contracts in long run enable in minimizing risk, Contract Lifecycle Management (CLM) is proactive, methodical management of the contract from initiation through award, compliance and renewal. In all together, contract lifecycle management also limits organizational liability and increase compliance with legal requirements.

Contract Lifecycle Management (CLM) also creates a centralized repository of documents that captures or extracts data, often from paper-based documents, relevant to the user's obligations under each legal contract. The extracted data is used to monitor the performance of obligations, manage business milestones, and provide some basis for business analytics. Moreover, whole process of management should be enabled in secure platform.

In conventional approach, a system for generating of a smart contract containing a plurality of templates and clause libraries is disclosed. The approach, talks about a blockchain module, configured to encrypt and store the generated contract on blockchain. Here, the clauses are generated after receiving specification in a programmable clause. More efficient approach would be to analyse the contract and predict the need of a user in real time. Whole automation process enables in improving the manual handling of the contact. The real time tracking of individual clauses also enables the organization in following legal compliances.

Hence, there is a need for an improved system for digital contract management and method to operate the same and therefore address aforementioned issues.

### BRIEF DESCRIPTION

In accordance with one embodiment of the disclosure, a system for digital contract management is provided. The system includes a processing subsystem. The processing system includes a retrieval module. The retrieval module is configured to retrieve one or more parameters from a plurality of users for generating a plurality of clauses for a contract. The processing subsystem also includes a template module. The template module is operatively coupled to the retrieval module. The template module is configured to identify the one or more parameters and provide a pre-arranged template. The processing subsystem includes a clause comparing module. The clause comparing module is operatively coupled the retrieval module. The clause comparing module is also configured to compare the one or more parameters with the plurality of clauses within the pre-arranged template. The processing subsystem also includes a clause generation module. The clause generation module is operatively coupled to the clause comparing module. The clause generation module is configured to generate the plurality of clauses by an analysis technique in the pre-arranged template.

The processing subsystem also includes a validation module. The validation module is operatively coupled to the clause generation module. The validation module is configured to validate a plurality of generated clauses of the contract based on a predefined set of instructions. The processing subsystem also includes a monitoring module. The monitoring module is operatively coupled to the validation module. The monitoring module is configured to monitor a validated contract according to the one or more parameters for a predefined time interval. The system also includes a memory subsystem. The memory subsystem is operatively coupled to processing subsystem. The memory subsystem is configured to store the one or more parameters, the plurality of the generated clauses, the plurality of validated clauses for the contract, the pre-arranged template and the contract on a blockchain platform.

In accordance with another embodiment of the disclosure, a method for digital contract management is provided. The method includes retrieving one or more parameters from a plurality of users for generating a plurality of clauses for a contract. The method also includes identifying the one or more parameters from the plurality of users. The method also includes providing a pre-arranged template corresponding to the one or more parameters. The method also includes comparing the one or more parameters with the plurality of clauses within the pre-arranged template. The method also includes generating the plurality of clauses by an analysis technique in the pre-arranged template. The method also includes validating the plurality of generated clauses of the contract. The method also includes monitoring validated contract according to the one or more parameters for a predefined time interval.

To further clarify the advantages and features of the present disclosure, a more particular description of the disclosure will follow by reference to specific embodiments thereof, which are illustrated in the appended figures. it is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for digital contract management in accordance with an embodiment of the present disclosure;

FIG. 2 is a schematic representation of an embodiment representing the system for digital contract management of FIG. 1 in accordance of an embodiment of the present disclosure;

FIG. 3 is a block diagram of a computer or a server in accordance with an embodiment of the present disclosure; and

FIG. 4 is a flowchart representing the steps of a method for digital contract management in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises” “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . ” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for digital contract management. The system includes a processing subsystem. The processing system includes a retrieval module. The retrieval module is configured to retrieve one or more parameters from a plurality of users for generating a plurality of clauses for a contract. The processing subsystem also includes a template module. The template module is operatively coupled to the retrieval module. The template module is configured to identify the one or more parameters and provide a pre-arranged template.

The processing subsystem includes a clause comparing module. The clause comparing module is operatively coupled the retrieval module. The clause comparing module is also configured to compare the one or more parameters with the plurality of clauses within the pre-arranged template. The processing subsystem also includes a clause generation module. The clause generation module is operatively coupled to the clause comparing module. The clause generation module is configured to generate the plurality of clauses by an analysis technique in the pre-arranged template.

The processing subsystem also includes a validation module. The validation module is operatively coupled to the clause generation module. The validation module is configured to validate a plurality of generated clauses of the contract based on a predefined set of instructions. The processing subsystem also includes a monitoring module. The monitoring module is operatively coupled to the validation module. The monitoring module is configured to monitor a validated contract according to the one or more parameters for a predefined time interval.

The system also includes a memory subsystem. The memory subsystem is operatively coupled to processing subsystem. The memory subsystem is configured to store the one or more parameters, the plurality of the generated clauses, the plurality of validated clauses for the contract, the pre-arranged template and the contract on a blockchain platform.

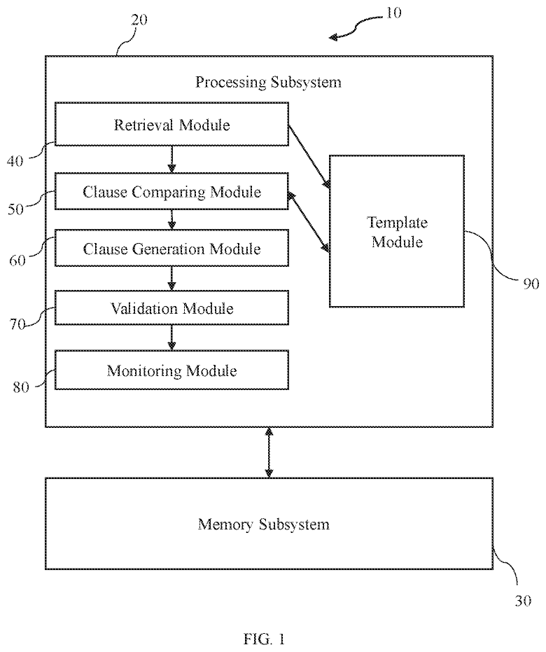

FIG. 1 is a block diagram representation of a system for digital contract management 10 in accordance with an embodiment of the present disclosure. As used herein, the term “contract management” refers to a process of managing contract creation, execution and analysis to maximize operational and financial performance at an organization, all while reducing financial risk. In another embodiment, the contract referred here may be also referred to as an agreement.

The system 10 for digital contract management includes a processing subsystem 20. The processing subsystem 20 includes a retrieval module 40. The retrieval module 40 is configured to retrieve one or more parameters from a plurality of users for generating a plurality of clauses for a contract.

In one embodiment, the one or more parameters comprises details regarding a contract execution. In such embodiment, the details comprise contract agreement type, contract party names, contract party details and the like.

In another embodiment, the details may be retrieved by an Optical Character Recognition software. In another such embodiment, the Optical Character Recognition software converts different types of documents, such as scanned paper documents, Portable Document Format (PDF) files or images captured by a digital camera into editable and searchable data.

Moreover, in one embodiment, the plurality of users comprises a promisor, a promisee, a third-party beneficiary, a legal official and the like. In one such embodiment, the plurality of clauses for a contract comprises assignment clause, confidentiality clause, consideration clause, force majeure clause, indemnification clause and the like.

As used herein, the term “promisor” is the party that makes the promise. As used herein, the term “promisee” is on the receiving end of the promise. As used herein, the term “third-party beneficiary” receives benefits of a contract, while not owing any obligation.

The processing subsystem 20 also includes a template module 90. The template module 90 is operatively coupled to the retrieval module 40. The template module 90 is configured to identify the one or more parameters and provide a pre-arranged template. In one embodiment, the pre-arranged template refers to service agreement contracts, employment contracts, partner contracts and the like. In another embodiment, identifying the one or more parameters includes identifying contract agreement type.

The processing subsystem 20 includes a clause comparing module 50. The clause comparing module 50 is operatively coupled the retrieval module 40. The clause comparing module 50 is also configured to compare the one or more parameters with the plurality of clauses within the pre-arranged template.

The processing subsystem 20 also includes a clause generation module 60. The clause generation module 60 is operatively coupled to the clause comparing module 50. The clause generation module 60 is configured to generate the plurality of clauses by an analysis technique in the pre-arranged template. In one embodiment, the analysing technique includes at least one of artificial intelligence and machine learning.

As used herein, “artificial intelligence” refers to sometimes called machine intelligence, is intelligence demonstrated by machines, in contrast to the natural intelligence displayed by humans and other animals, such as visual perception, speech recognition, decision-making, and translation between languages. As used herein, “machine teaming” refers to an application of artificial intelligence (AI) that provides systems the ability to automatically learn and improve from experience without being explicitly programmed.

The processing subsystem 20 further comprises a clause modification module. The clause modification module is operatively coupled to the clause comparing module 50. The clause modification module is configured to modify the plurality of generated clauses by a modifying technique in the pre-arranged template. In one embodiment, the modifying technique includes at least one of artificial intelligence and machine teaming, in another embodiment, the plurality of user may negotiate on terms and condition online for any time duration. In another such embodiment, highlighting or flagging any particular clauses for later negotiation is also allowed.

The processing subsystem 20 also includes a validation module 70. The validation module 70 is operatively coupled to the clause generation module 60. The validation module 70 is configured to validate a plurality of generated clauses of the contract based on a predefined set of instructions. In one embodiment, the predefined set of instructions refers to the “yes” and “no” inputs from the review of the plurality of users. In another embodiment, the predefined set of instructions refers to any predefined conditions introduced by the plurality of users in the system 10.

Furthermore, in one embodiment, the validation of the one of the plurality of generated clauses of the contract by the plurality of users comprises addition of at least one comment for verification before final authorization. In one such embodiment, the comment can be key specific feature that has to be verified during final process. In another such embodiment, the comment may be addressed to one of the plurality of users.

The processing subsystem 20 also includes an authorization module. The authorization module is operatively coupled to the validation module 70. The authorization module is configured to authorize the contract after validating the plurality of generated clauses of the contract. In one embodiment, the authorization of contract may be providing initials or signature of the plurality of users. In another embodiment, the authorization of the contract is provided after checking the legal provisions of the plurality of validated clauses.

The processing subsystem 20 also includes a monitoring module 80. The monitoring module 80 is operatively coupled to the validation module 70. The monitoring module 80 is configured to monitor a validated contract according to the one or more parameters for a predefined time interval. In one embodiment, monitoring of the validated contract also involves reminding of promised commitments regarding particular tasks in the one of the plurality of clauses.

In another embodiment, the predefined time interval may be based on one or more inputs received from the plurality of users. In such embodiment, the plurality of users may be notified according to the need by at least one of alerts, electronic mail notification and the like. In one such embodiment, the alerts notified may be of high, medium and low tracking.

The system 10 also includes a memory subsystem 30. The memory subsystem 30 is operatively coupled to processing subsystem 20. The memory subsystem 30 is configured to store the one or more parameters, the plurality of the generated clauses, the plurality of validated clauses for the contract, the pre-arranged template and the contract on a blockchain platform. As used herein, the term “blockchain” refers to a decentralized, distributed and public digital ledger that is used to record transactions across many computers so that any involved record cannot be altered retroactively, without the alteration of all subsequent blocks.

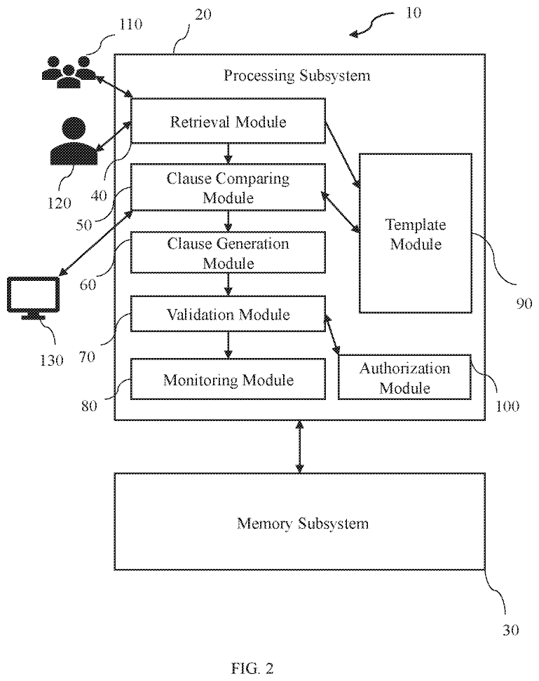

FIG. 2 is a schematic representation of an embodiment representing the system for digital contract management 10 of FIG. 1 in accordance of an embodiment of the present disclosure. In an exemplary embodiment, an employee contract is to be executed between first-party organization X 110 and second-party user Y 120. As used herein, the term “employee contract” refers to the traditional document used in relationships between employees and employers for the purpose of laying out the rights, responsibilities, and obligations of both parties during the employment period.

The first-party organization X 110 provides to the system 10 all information regarding the details of the contract. A retrieval module 40 is configured to retrieve the one or more parameters from the provided details. A template module 90 in the system 10, then identifies the type of contract, and provides a template of the employee contract. Here, a clause comparing module 50 enables comparing of the one or more retrieved parameters with the plurality of clauses within the pre-arranged template.

In such exemplary embodiment, a clause generation module 60 enables in generating clauses specific to the generating of employee contract. Subject matter of few generated clauses is at least one of terms of employment, employee responsibilities, employee benefits, employment absence, dispute resolution, nondisclosure agreements, ownership agreements, assignment clauses, employment opportunity limitations, grounds for termination and the like. The system 10 uses analysis technique such as machine learning for generating clauses with respect to same type of contract in real time.

A clause modification module enables in modifying the generated clauses according the need of the first-party organization X 110 and the second-party user Y 120. The modifying technique uses prior history of the first-party organization X 110 in understanding the organization X 110 need.

After all modification and generation, the first-party organization X 110 and the second-party user Y 120 validates the contract online. The validation module 70 also enables in validating each clause in single time. Here, both parties the first-party organization X 110 and the second-party user Y 120, may negotiate on terms and condition online for a time duration. The authorization module 100 enables in final authorization from both the parties, for example signature. Here, before final authorization small key features may be checked and verified as commented by different hierarchy of people in the first-party organization X 110.

Moreover, in due process, a monitoring module 80 also enables in alerting the organization X 110 about certain conditions. For example, the organization X 110 may track the probation period of employee Y 120 and alert the organization X 110 at appropriate time.

Here, all contract documents created and negotiated are present in the blockchain platform. Thus, the integrity of the employee contract remains same after the whole process is completed.

Moreover, the retrieval module 40, the template module 90, the clause comparing module 50, the clause generation 60, the validation module 70 and the monitoring module 80 of FIG. 2 is substantially similar to the retrieval module 40, the template module 90, the clause comparing module 50, the clause generation 60, the validation module 70 and the monitoring module 80 of FIG. 1.

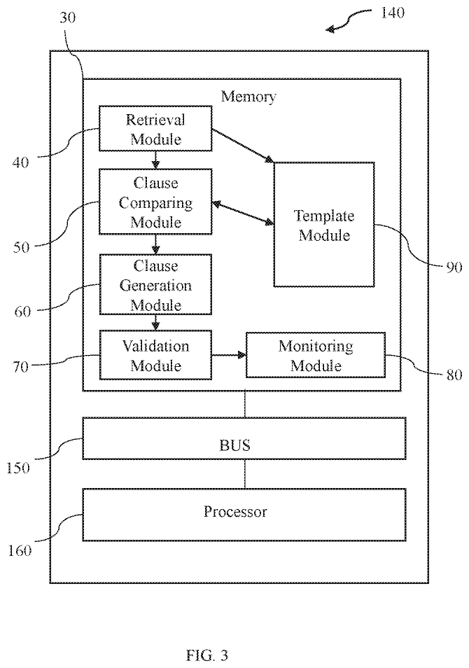

FIG. 3 is a block diagram of a computer or a server 140 in accordance with an embodiment of the present disclosure. The server 140 includes processor(s) 160, and memory 30 coupled to the processor(s) 160.

The processor(s) 160, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 30 includes a plurality of modules stored in the form of executable program which instructs the processor 160 to perform the method steps illustrated in FIG. 1. The memory 30 has following modules: the retrieval module 40, the template module 90, the clause comparing module 50, the clause generation module 60, the validation module 70 and the monitoring module 80. The retrieval module 40 is configured to retrieve one or more parameters from a plurality of users for generating a plurality of clauses for a contract. The template module 9C) is configured to identify the one or more parameters and provide a pre-arranged template. The clause comparing module 50 is also configured to compare the one or more parameters with the plurality of clauses within the pre-arranged template. The clause generation module 60 is configured to generate the plurality of clauses by an analysis technique in the template. The validation module 70 is configured to validate a plurality of generated clauses of the contract based on a predefined set of instructions. The monitoring module 80 is configured to monitor a validated contract according to the one or more parameters for a predefined time interval.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 160.

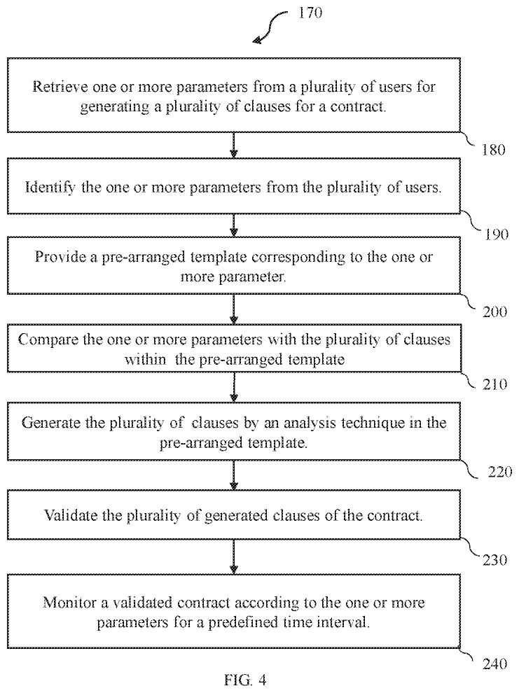

FIG. 4 is a flowchart representing the steps of a method for digital contract management 170 in accordance with an embodiment of the present disclosure. The method 170 includes retrieving one or more parameters from a plurality of users for generating a plurality of clauses for a contract in step 180. In one embodiment, retrieving the one or more parameters from the plurality of users for generating the plurality of clauses for the contract includes retrieving the one or more parameters from the plurality of users for generating the plurality of clauses for the contract by a retrieval module.

The method 170 also includes identifying the one or more parameters from the plurality of users in step 190. In one embodiment, identifying the one or more parameters from the plurality of users includes identifying the one or more parameters from the plurality of users by a template module.

The method 170 also includes providing a pre-arranged template corresponding to the one or more parameters in step 200. In one embodiment, providing the pre-arranged template corresponding to the one or more parameters includes providing the pre-arranged template corresponding to the one or more parameters by the template module.

The method 170 also includes comparing the one or more parameters with the plurality of clauses within the pre-arranged template in step 210. In one embodiment, comparing the one or more parameters with the plurality of clauses within the pre-arranged template includes comparing the one or more parameters with the plurality of clauses within the pre-arranged template by a clause comparing module.

The method 170 includes generating the plurality of clauses by an analysis technique in the pre-arranged template in step 220. In one embodiment, generating the plurality of clauses by the analysis technique in the pre-arranged template includes generating the plurality of clauses by the analysis technique in the pre-arranged template by a clause generation module.

The method 170 further includes modifying the plurality of generated clauses by a modifying technique in the pre-arranged template. In one embodiment, modifying the plurality of generated clauses by the modifying technique in the pre-arranged template includes modifying the plurality of generated clauses by the modifying technique in the pre-arranged template by a clause modification module.

The method 170 also includes validating the plurality of generated clauses of the contract in step 230. In one embodiment, validating the plurality of generated clauses of the contract includes validating the plurality of generated clauses of the contract by a validation module. In another embodiment, validating the plurality of generated clauses of the contract includes validating one of the plurality of generated clauses of the contract by the plurality of users comprises addition of at least one comment for cross-checking before final authorization.

The method 170 also includes monitoring a validated contract according to the one or more parameters for a predefined time interval in step 230. In one embodiment, monitoring the validated contract according to the one or more parameters for the predefined time interval includes monitoring the validated contract according to the one or more parameters for the predefined time interval by a monitoring module.

In another embodiment, monitoring the validated contract according to the one or more parameters for the predefined time interval includes monitoring the validated contract according to the one or more parameters for the predefined time interval is based on inputs from the plurality of users.

The method 170 further comprising authorizing the contract after validating the plurality of generated of the contract. in one embodiment, authorizing the contract after validating the plurality of generated clauses of the contract includes authorizing the contract after validating the plurality of generated clauses of the contract by an authorization module.

The method 170 further comprising storing the retrieved one or more parameters, the plurality of generated clauses, the plurality of modified clauses, the plurality of validated clauses for the contract, the pre-arranged template and the contract on a blockchain platform. In one embodiment, storing the retrieved the one or more parameters, the plurality of generated clauses, the plurality of modified clauses, the plurality of validated clauses for the contract, the pre-arranged template and the contract on a blockchain platform includes storing the retrieved the one or more parameters, the plurality of generated clauses, the plurality of modified clauses, the plurality of validated clauses for the contract, the pre-arranged template and the contract on a blockchain platform by a memory subsystem.

Present disclosure of a system for digital contract management provides an end to end life cycle management of a contract. The present disclosure provides a block chain platform for generating, modifying or archiving of any contract. Thus, the integrity of contract is protected during the whole process. Here, the clause generation and the clause modification further enable in analysing the contract and predict the need of a user in real time.

Whole automation process enables in improving the manual handling of the contact. The real time tracking of individual clauses also enables the organization in following legal compliances. Hence, the present disclosure makes total drafting and analysing process of any particular contract less time taking and secure.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system for digital contract management 10, comprising:
a processing subsystem 20, comprising:
a retrieval module 40 configured to retrieve one or more parameters from a plurality of users for generating a plurality of clauses for a contract;
a template module 90 operatively coupled to the retrieval module 40, and configured to identify the one or more parameters and provide a pre-arranged template;
a clause comparing module 50 operatively coupled to the retrieval module 40, and configured to compare the one or more parameters with the plurality of clauses within the pre-arranged template;
a clause generation module 60 operatively coupled to the clause comparing module 50, and configured to generate the plurality of clauses by an analysis technique in the pre-arranged template;
a validation module 70 operatively coupled to the clause generation module 60, and configured to validate a plurality of generated clauses of the contract based on a predefined set of instructions;
a monitoring module 80 operatively coupled to the validation module 70, and configured to monitor a validated contract according to the one or more parameters for a predefined time interval; and
a memory subsystem operatively 30 coupled to processing subsystem 20, and configured to store the one or more parameters, the plurality of the generated clauses, the plurality of validated clauses for the contract, the pre-arranged template and the contract on a blockchain platform.

2. The system 10 as claimed in claim1, wherein further comprising a clause modification module operatively coupled to the clause comparing module 50, and configured to modify the plurality of generated clauses by a modifying technique in the pre-arranged template.

3. The system 10 as claimed in claim 1, wherein validation of the one of the plurality of generated clauses of the contract by the plurality of users comprises addition of at least one comment for verification before final authorization.

4. The system 10 as claimed in claim 1, wherein further comprising an authorization module operatively coupled to the validation module 70, and configured to authorize the contract after validating the plurality of generated clauses of the contract.

5. The system 10 as claimed in claim 1, wherein monitoring the validated contract for the predefined time interval based on one or more inputs received from the plurality of users.

6. A method for digital contract management 170, comprising:
retrieving, by a retrieval module, one or more parameters from a plurality of users for generating a plurality of clauses for a contract 180;
identifying, by a template module, the one or more parameters from the plurality of users 190;
providing, by the template module, a pre-arranged template corresponding to the one or more parameters 200;
comparing, by a clause comparing module, the one or more parameters with the plurality of clauses within the pre-arranged template 210;
generating, by a clause generation module, the plurality of clauses by an analysis technique in the template 220;
validating, by a validation module, the plurality of generated clauses of the contract 230; and monitoring, by a monitoring module, a validated contract according to the one or more parameters for a predefined time interval 240.

7. The method 170 as claimed in claim 6, further comprising authorizing, by an authorization module, the contract after validating the plurality of generated clauses of the contract.

8. The method 170 as claimed in claim 6, wherein validating one of the plurality of generated clauses of the contract by the plurality of users comprises addition of at least one comment for cross-checking before final authorization.

9. The method 170 as claimed in claim 6, further comprising modifying, by a clause modification module, the plurality of generated clauses by a modifying technique in the pre-arranged template.

10. The method 170 as claimed in claim 6, wherein monitoring, by a monitoring module, the validated contract for the predefined time interval based on inputs from the plurality of users.

11. The method 170 as claimed in claim 6, wherein storing, by a memory subsystem, the retrieved one or more parameters, the plurality of generated clauses, the plurality of modified clauses, the plurality of validated clauses for the contract, the template and the contract on a blockchain platform.
